(19) United States
(12) Patent Application Publication
(10) Pub. No.: US 2026/0183843 A1
(43) Pub. Date: Jul. 2, 2026

(54) 3D PRINTER WITH EXPANDABLE ENCLOSED BUILD CHAMBER FOR METAL ADDITIVE MANUFACTURING

(71) Applicant: Generational Systems, LLC, Auburn, AL (US)

(72) Inventors: Michael Knotts, Montgomery, AL (US); Travis Thompson, Auburn, AL (US)

(21) Appl. No.: 19/552,512

(22) Filed: Feb. 27, 2026

Related U.S. Application Data
(63) Continuation of application No. PCT/US2024/044025, filed on Aug. 27, 2024.
(60) Provisional application No. 63/535,836, filed on Aug. 31, 2023.

(51) Int. Cl. B22F 12/00; B22F 12/17; B22F 12/33; B22F 12/50; B33Y 30/00

(52) U.S. Cl. CPC B22F 12/38; B22F 12/17; B22F 12/33; B22F 12/50; B33Y 30/00

(57) ABSTRACT

A 3D printer (100) including an expandable build chamber (102), a print bed (122), and a print head (124) is disclosed. The expandable build chamber (102) is defined by a plurality of stationary walls (104) and an adjustable wall (106) enclosing an open interior (116) having an open interior volume. The print bed (122) is configured to receive the feedstock material from the print head (124). The print bed (122) is disposed within the open interior (116). The print head (124) is configured to deposit the feedstock material onto the print bed (122). The print head (124) is disposed within the open interior (116). The adjustable wall (106) is configured to move away from the open interior (116) to increase the open interior volume as the print head (124) deposits the feedstock material onto the print bed (122) while maintaining isolation of the open interior (116) from the ambient environment.

### CROSS-REFERENCES TO RELATED APPLICATIONS

This application is a continuation of International Patent Application No. PCT/US2024/044025, filed Aug. 27, 2024, which claims priority to U.S. Provisional Patent Application No. 63/535,836 filed Aug. 31, 2023, and titled “3D Printer With Expandable Enclosed Build Chamber For Metal Additive Manufacturing.”

### TECHNICAL FIELD

The present disclosure relates generally to the field of additive manufacturing, also known as 3D printing. More particularly, the present disclosure pertains to 3D printers having an expandable enclosed build chamber for manufacturing metallic articles of manufacture.

### BACKGROUND ART

Metal additive manufacturing, commonly known as metal 3D printing, utilizes various methods to create solid metal objects. These methods include powder bed fusion, direct energy deposition, binder jetting, and bound powder extrusion. Each process involves depositing metal powder feedstock onto a printing area and applying heat to bind the powder into a solid object.

For instance, in powder bed fusion, a thin layer of powder is spread over the print area, and a cross-section of the final product is selectively melted into the powder layer using a laser or electron beam. This process is repeated layer by layer to build the complete object.

Direct energy deposition involves depositing metal powder and fusing it together using a laser, sometimes with the aid of metal wire. The laser melts and fuses the feedstock to form the final product.

Binder jetting, another method, includes spreading a thin layer of metal powder over the print area and selectively spraying a binding polymer onto the powder to create a cross-section of the desired object. This layer-by-layer process is repeated, and the bound metal powder is then sintered to remove the binding agent and fuse the layers into the final product.

Bound powder extrusion involves extruding metal powder bound in a waxy polymer to form an intermediate product, which is subsequently sintered to remove the polymer and fuse the metal powder into the final object.

Despite their advantages, existing metal 3D printing techniques have certain drawbacks. Metal 3D printing techniques are energy intensive due to the high temperatures required to melt metals commonly used in metal 3D printing. Existing metal 3D printers are often energy inefficient as significant amounts of heat are lost to the ambient environment.

Moreover, many metal 3D printing techniques are sensitive to changes in ambient conditions, such as temperature or the composition of the ambient air. Some metal 3D printing techniques require shielding gas to prevent unintentional oxidation of the metal in the printed object. Further, many existing 3D printers do not include build chambers capable of expanding during printing while maintaining the desired ambient conditions.

### SUMMARY OF INVENTION

In view of at least some of the above-referenced problems in conventional metal 3D printing, an exemplary object of the present disclosure may be to provide a 3D printer configured to expand during use while maintaining desired ambient conditions. Particularly, the 3D printer may include an expandable build chamber configured to increase and decrease its interior volume while maintaining isolation of its interior from the ambient environment.

In some exemplary embodiments, the present disclosure provides a 3D for forming a 3D object from a feedstock material. The 3D printer may include an expandable build chamber. The expandable build chamber may be defined by a plurality of stationary walls and an adjustable wall. The plurality of stationary walls and the adjustable wall may enclose an open interior isolated from the ambient environment and having an open interior volume.

The 3D printer may also include a print bed for receiving the feedstock material as it is formed into the 3D object. The print bed may be disposed within the open interior of the expandable build chamber. The 3D printer may also include a print head for depositing the feedstock material onto the print bed. The print head may be disposed within the open interior. The adjustable wall may be configured to move away from the open interior to increase the open interior volume as the print head deposits the feedstock material onto the print bed while maintaining isolation of the open interior from the ambient environment.

Other aspects of the invention are described further with respect to the description of embodiments and the claims.

### BRIEF DESCRIPTION OF THE DRAWINGS

FIG. 1A is a front, top perspective view of an embodiment of a 3D printer in accordance with the present disclosure. In FIG. 1A, some of the stationary walls are formed from an opaque material.

FIG. 1B is a rear, top perspective view of the 3D printer of FIG. 1A.

FIG. 2 is a front, top perspective view of an embodiment of a 3D printer in accordance with the present disclosure. In FIG. 2, the stationary walls are formed from a transparent material.

FIG. 3 is a rear, bottom perspective view of the 3D printer of FIG. 2.

FIG. 4 is a front elevation view of the 3D printer of FIG. 2.

FIG. 5 is a bottom cross-sectional view of the 3D printer of FIG. 2 taken along line 5-5 shown in FIG. 4 looking in the direction of the arrows.

FIG. 6 is a top cross-sectional view of the 3D printer of FIG. 2 taken along line 6-6 shown in FIG. 4 looking in the direction of the arrows.

### DESCRIPTION OF EMBODIMENTS

Reference will now be made in detail to embodiments of the present disclosure, one or more drawings of which are set forth herein. Each drawing is provided by way of explanation of the present disclosure and is not a limitation. It will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

Unless specifically stated otherwise, any part of the apparatus of the present disclosure may be made of any appropriate or suitable material including, but not limited to, metal, alloy, polymer, polymer mixture, wood, composite, or any combination thereof.

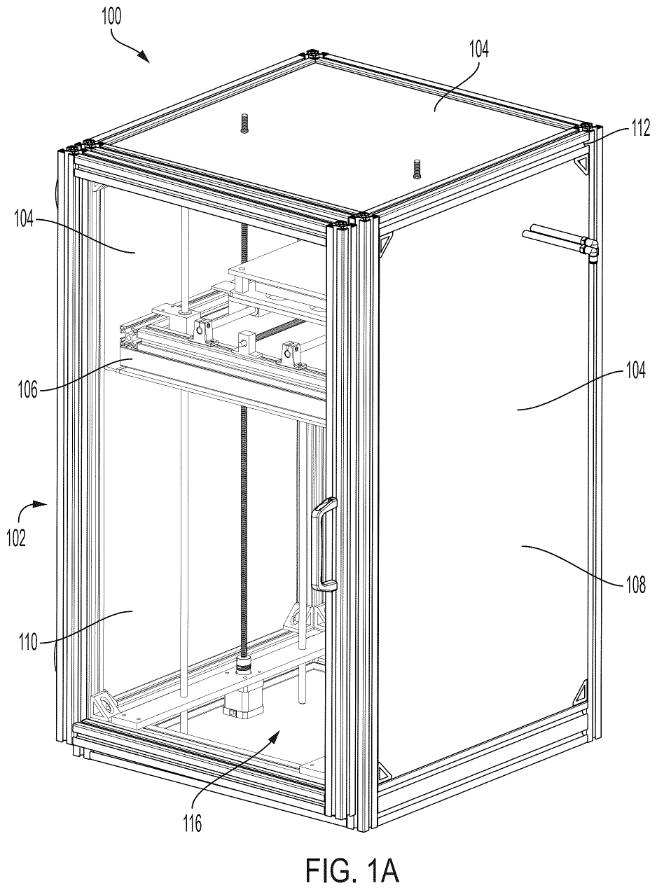

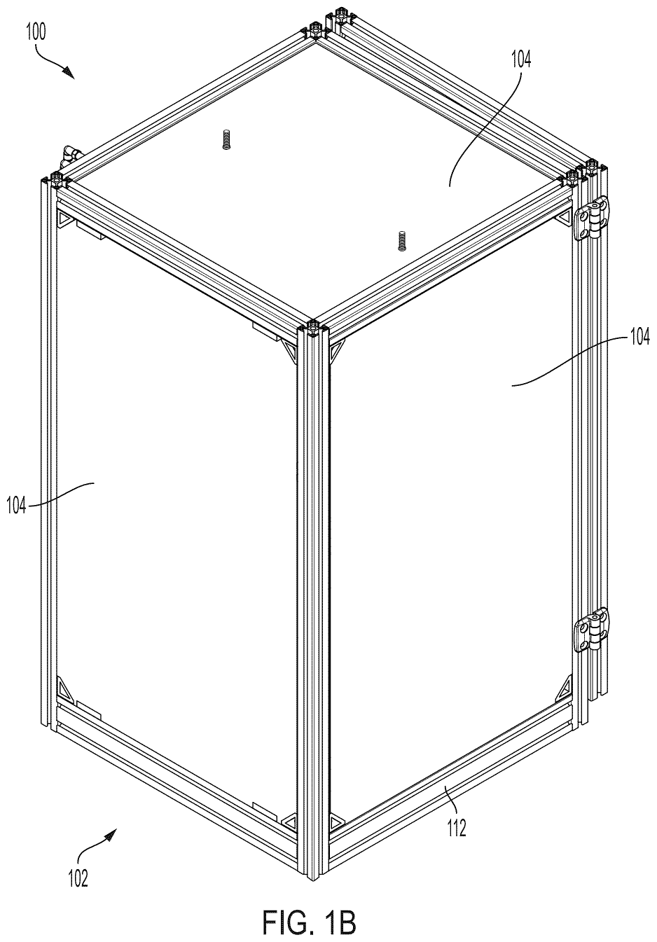

Referring to FIGS. 1A-6, a 3D printer 100 is disclosed herein. The 3D printer 100 may also be referred to herein as a metal 3D printer 100. The 3D printer may include an expandable build chamber 102 for maintaining the desired conditions for 3D printing. The expandable build chamber 102 forms a closed environment within which 3D printer 100 prints a 3D object (not shown).

As discussed above, 3D printers, and particularly metal 3D printers, are energy intensive due to the high temperatures required to melt the feed material, namely, metal. The expandable build chamber 102 may be insulated, as discussed herein, to reduce the energy requirements of the 3D printer 100 and stabilize the temperature within the expandable build chamber 102 during a build. As used herein, a “build” refers to a 3D printing run that produces the 3D object. When starting a build, it may be desirable for the expandable build chamber 102 to have a smaller volume to reduce the time and energy needed to heat the expandable build chamber 102 to the desired temperature and/or to reduce the shielding gas needed to create an inert environment within the expandable build chamber 102. However, it may be necessary to increase the volume of the expandable build chamber 102 as the 3D object being printed increases in size during the build. Thus, the expandable build chamber 102 is capable of increasing in volume during the course of a build to reduce the overall energy requirements of the build without interfering with the build.

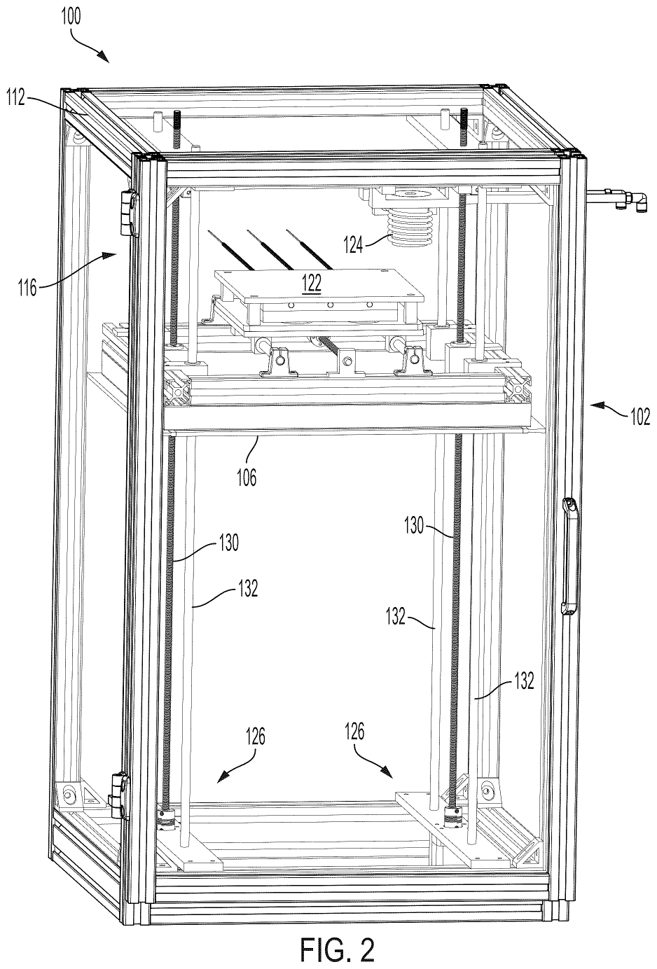

The expandable build chamber 102 is defined by a plurality of stationary walls 104 and an adjustable wall 106. As used herein, “stationary” describes the fixed nature of the plurality of stationary walls 104 when the 3D printer 100 is in use. When the 3D printer 100 is not in use, the plurality of stationary walls 104 may be configured to be moved, adjusted, or repositioned. “Adjustable” describes the moveable nature of the adjustable wall 106 when the 3D printer 100 is in use. However, the adjustable wall 106 may be stationary when the 3D printer 100 is in use if no adjustment is necessary or desired. In FIGS. 1A-1B, some of the stationary walls 104 are shown as opaque. In FIGS. 2-6, the stationary walls 104 are present but formed from clear materials so that the internal components of 3D printer 100 are viewable.

As shown in FIGS. 1A-1B, the plurality of stationary walls 104 and/or the adjustable wall 106 may include an exterior surface 108 and an interior surface 110 opposite the exterior surface 108. The interior surface 110 of the plurality of stationary walls 104 and/or the adjustable wall 106 may be rigid to allow for a seal 118 (discussed elsewhere herein) to be created between the plurality of stationary walls 104 and/or the adjustable wall 106.

The plurality of stationary walls 104 and/or the adjustable wall 106 may be rectangular. For example, the plurality of stationary walls 104 and/or the adjustable wall 106 may be square. The plurality of stationary walls 104 may include five walls that, together with the adjustable wall 106, form the expandable build chamber 102. The expandable build chamber 102 may be formed in the shape of a rectangular prism, such as a cube. In the embodiment of FIGS. 1A-6, the plurality of stationary walls 104 includes four sidewalls and a top wall, and the adjustable wall 106 is a bottom wall. In some embodiments, the plurality of stationary walls 104 includes four sidewalls and a bottom wall, and the adjustable wall 106 is a top wall. In other embodiments, the plurality of stationary walls 104 includes a top wall, a bottom wall, and three sidewalls, and the adjustable wall 106 is a sidewall. The plurality of stationary walls 104 may be directly secured to one another. The expandable build chamber 102 may also include a frame 112 connecting and forming a seal between the plurality of stationary walls 104. In some embodiments, the expandable build chamber 102 may include additional adjustable walls 106. For example, the expandable build chamber 102 may include four stationary walls 104 and two adjustable walls 106.

The plurality of stationary walls 104 and the adjustable wall 106 may be heat resistant (i.e., do not burn, melt, or otherwise degrade under high temperatures). 3D printers typically operate in the range of 200° F. to 1000° F. Metal 3D printers may even operate in ranges that exceed 1000° F. The plurality of stationary walls 104 and the adjustable wall 106 should be able to withstand temperatures of 200° F. to 1000° F. depending on the temperatures at which the 3D printer 100 will be used. For example, the plurality of stationary walls 104 and the adjustable wall 106 may be heat resistant up to a temperature of about 200° F., about 300° F., about 400° F., about 500° F., about 600° F., about 700° F., about 800° F., about 900° F., about 1000° F., or about 1100° F. In some embodiments, the heat resistance of the plurality of stationary walls 104 and the adjustable wall 106 are substantially equal. In other embodiments, the heat resistance of the plurality of stationary walls 104 may be higher or lower than the heat resistance of the adjustable wall 106. For example, the adjustable wall 106 may have a higher heat resistance than the plurality of stationary walls 104 when the adjustable wall 106 contacts, supports, or is adjacent to high-temperature components of the 3D printer 100, such as the print bed 122, print head 124, or heating system 144 (discussed elsewhere herein). As another example, the adjustable wall 106 may have a lower heat resistance than the plurality of stationary walls 104 when it is distanced from high-temperature components of the 3D printer or is “shielded” from high-temperature components of the 3D printer 100 by other components of the 3D printer 100.

The plurality of stationary walls 104 and the adjustable wall 106 may be insulated to reduce energy loss during 3D printing and/or to reduce injuries to bystanders near the expandable build chamber 102. When insulated, the plurality of stationary walls 104 and the adjustable wall 106 may be multi-layer. For example, the plurality of stationary walls 104 and the adjustable wall 106 may comprise a frame, mineral wool disposed in or about the frame, and interior and exterior sheet metal panels on opposite sides of the frame and mineral wool. The plurality of stationary walls 104 and/or the adjustable wall 106 may have an R-value (in units of ° F.·ft²·h/BTU) of 1 or greater, 2.5 or greater, 4 or greater, 5 or greater, 7 or greater, 10 or greater, 15 or greater, 20 or greater, 30 or greater, or 40 or greater. In some embodiments, the R-value of the plurality of stationary walls 104 and/or the adjustable wall 106 ranges from about 3 to about 5, about 4 to about 5, or about 4 to about 4.5. For example, the R-value of the plurality of stationary walls 104 and the adjustable wall 106 may be about 4.3. In some embodiments, the R-value of the plurality of stationary walls 104 and the adjustable wall 106 are substantially equal. In other embodiments, the R-value of the plurality of stationary walls 104 may be higher or lower than the heat resistance of the adjustable wall 106. The adjustable wall 106 may have a higher R-value than the plurality of stationary walls 104 when the adjustable wall 106 contacts, supports, or is adjacent to high-temperature components of the 3D printer 100. As another example, the adjustable wall 106 may have a lower R-value than the plurality of stationary walls 104 when it is distanced from high-temperature components of the 3D printer 100 or is “shielded” from high-temperature components of the 3D printer 100 by other components of the 3D printer 100.

The plurality of stationary walls 104 and the adjustable wall 106 may be made from suitable heat-resistant and insulative materials. Materials suitable for use in the plurality of stationary walls 104 and/or the adjustable wall 106 include but are not limited to metals (including alloys), such as iron, nickel, lead, steel, and bronze; ceramics, such as alumina, alumina-zirconia, composites, zirconia MgO, aluminum nitride, silicon carbide, silicon nitride, quartz, and glass; mineral wools, such as rock wool or slag wool; polymers, such as cellulose, polyurethane, polystyrene, polyimides, polyacetals, and polycarbonates; and combinations thereof, such as fiberglass. The plurality of stationary walls 104 and/or the adjustable walls 106 may be formed from multiple layers (not shown) that may be made from the same or different materials.

In some embodiments, plurality of stationary walls 104 and the adjustable wall 106 may be vacuum insulated or include one or more insulative coatings such as films, finishes, or other layers. Such coatings may be disposed on the exterior surface 108 of, the interior surface 110 of, or between layers of the plurality of stationary walls 104 and/or the adjustable wall 106. The plurality of stationary walls 104 and the adjustable wall 106 may be made from the same materials or different materials. The plurality of stationary walls 104 and/or the adjustable wall 106 may be transparent as shown in FIGS. 2-6 to allow a viewer to observe the 3D printing or may be opaque as shown in FIGS. 1A-1B to prevent observation of the 3D printing or to prevent light from entering the expandable build chamber 102. In some embodiments, one of the plurality of stationary walls 104 is a door 114 or includes a door 114 to allow access into the expandable build chamber 102.

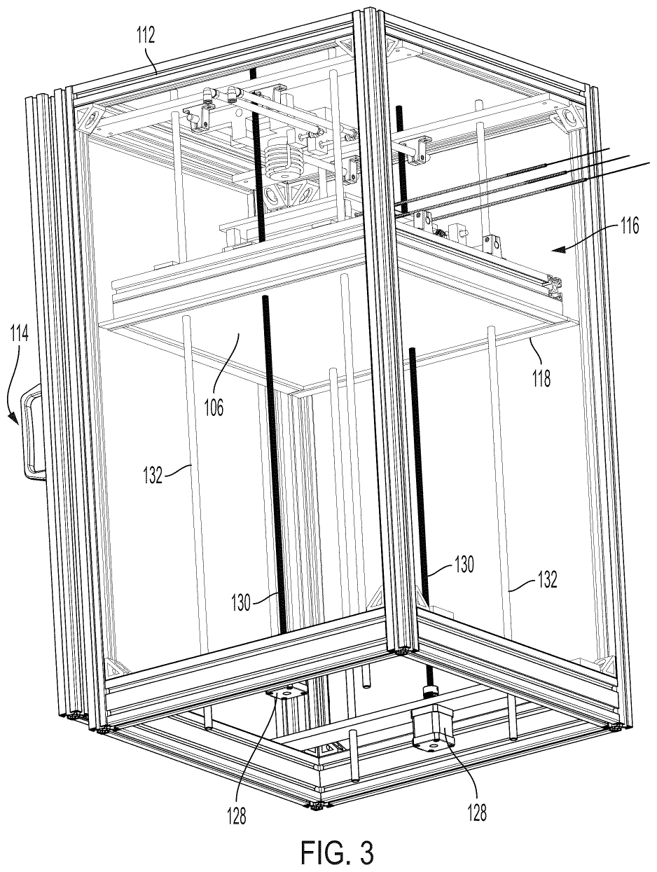

As shown in FIGS. 2-3, the expandable build chamber 102 may include an open interior 116 enclosed by the plurality of stationary walls 104 and the adjustable wall 106. The open interior 116 may be separated or isolated from the ambient environment. The open interior 116 may have a volume that is adjustable while maintaining separation or isolation of the open interior 116 from the ambient environment. The adjustable wall 106 may be configured to move toward the open interior 116 to decrease the volume of the open interior 116 and move away from the open interior 116 to increase the volume of the open interior 116. When the adjustable wall 106 is a bottom wall, the adjustable wall 106 may be configured to translate upward to decrease the volume of the open interior 116 and translate downward to increase the volume of the open interior 116. When the adjustable wall 106 is a top wall, the adjustable wall 106 may be configured to translate downward to decrease the volume of the open interior 116 and translate upward to increase the volume of the open interior 116. When the adjustable wall 106 is a sidewall, the adjustable wall 106 may be configured to translate laterally inward toward the open interior 116 to decrease the volume of the open interior 116 and laterally outward from the open interior 116 to increase the volume of the open interior 116. At the beginning of a build, the volume of the open interior 116 may be at its minimum and may increase during the course of the build.

As discussed above, many 3D printing techniques are sensitive to changes in ambient conditions, such as temperature or the composition of the ambient air. The adjustable wall 106 may be configured to adjust the volume of the open interior 116 to prevent significant or rapid changes to the conditions inside the open interior 116. For example, the air outside of the expandable build chamber 102 may be cooler than or a different composition than the air inside the expandable build chamber 102. Rapidly increasing the volume of the open interior 116 may draw in air from outside of the expandable build chamber 102 into the open interior 116, which may, in turn, reduce the temperature inside the expandable build chamber 102 or alter the air composition inside of the expandable build chamber 102. Such changes to the air temperature or composition within the expandable build chamber 102 during the 3D printing process may affect the quality of the build.

To help stabilize the conditions within the open interior 116 during the 3D printing process, the adjustable wall 106 may move towards and away from the open interior 116 at a limited speed such that the volume of the open interior 116 increases or decreases at a maximum rate. The maximum rate of increase or decrease in the volume of the open interior 116 during the 3D printing process may be about 0.1% per minute or less, about 0.5% per minute or less, about 1% per minute or less, about 2% per minute or less, about 3% per minute or less, about 5% per minute or less, or about 10% per minute or less.

When 3D printing is not actively taking place in the build chamber 102, it may be beneficial to rapidly change the volume of the open interior 116 of the build chamber 102. For example, rapidly expanding the volume of the open interior 116 after 3D printing is complete may help to cool the build chamber 102 and decrease down time between prints.

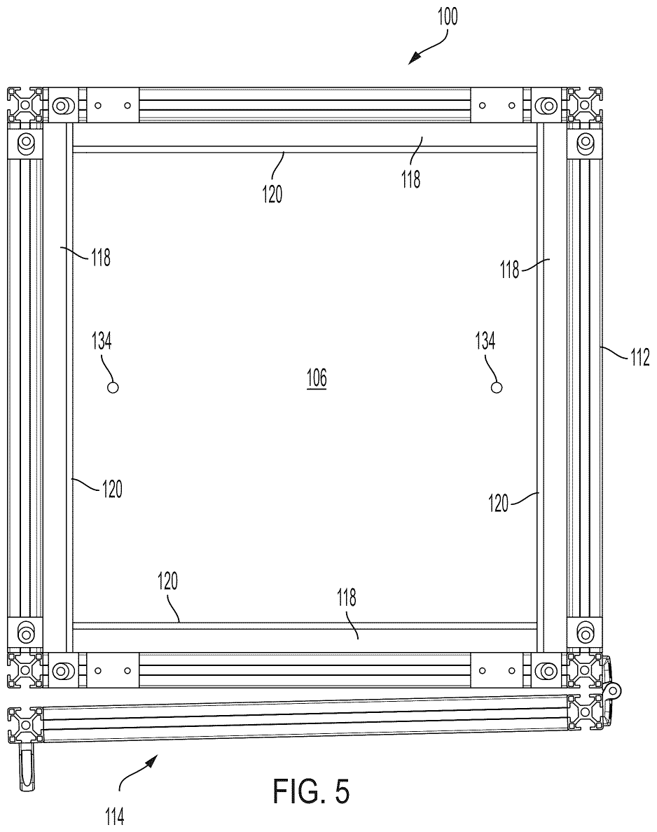

The expandable build chamber 102 may include a seal 118 configured to prevent or reduce the flow of gas between the plurality of stationary walls 104 and the adjustable wall 106 to prevent significant or rapid changes in the conditions within the open interior 116. As shown in FIG. 5, the seal 118 may extend about the perimeter of the adjustable wall 106. The seal 118 may be in contact with the plurality of stationary walls 104 about the perimeter of the adjustable wall 106. The seal 118 may be configured to maintain contact with the plurality of stationary walls 104 as the adjustable wall 106 translates towards or away from the open interior 116.

In some embodiments, the seal 118 may be integral with the adjustable wall 106. In other embodiments, the seal 118 may be affixed to the adjustable wall 106. For example, the adjustable wall 106 may include a fastener 120, such as a clamp, configured to secure the seal 118 to the adjustable wall 106. Alternatively, adhesives or welding may be used to secure the seal 118 to the adjustable wall 106. The seal 118 may be a rope gasket or a brush seal. The seal 118 may be heat resistant up to a temperature of about 200° F., about 300° F., about 400° F., about 500° F., about 600° F., about 700° F., about 800° F., about 900° F., about 1000° F., or about 1100° F. The seal 118 may also be insulative. For example, the seal 118 may have an R-value (in units of ° F·ft²·h/BTU) of 1 or greater, 2.5 or greater, 4 or greater, 5 or greater, 7 or greater, 10 or greater, 15 or greater, 20 or greater, 30 or greater, or 40 or greater. In some embodiments, the R-value of the seal 118 ranges from about 3 to about 5, about 4 to about 5, or about 4 to about 4.5. For example, the R-value of the seal 118 may be about 4.3.

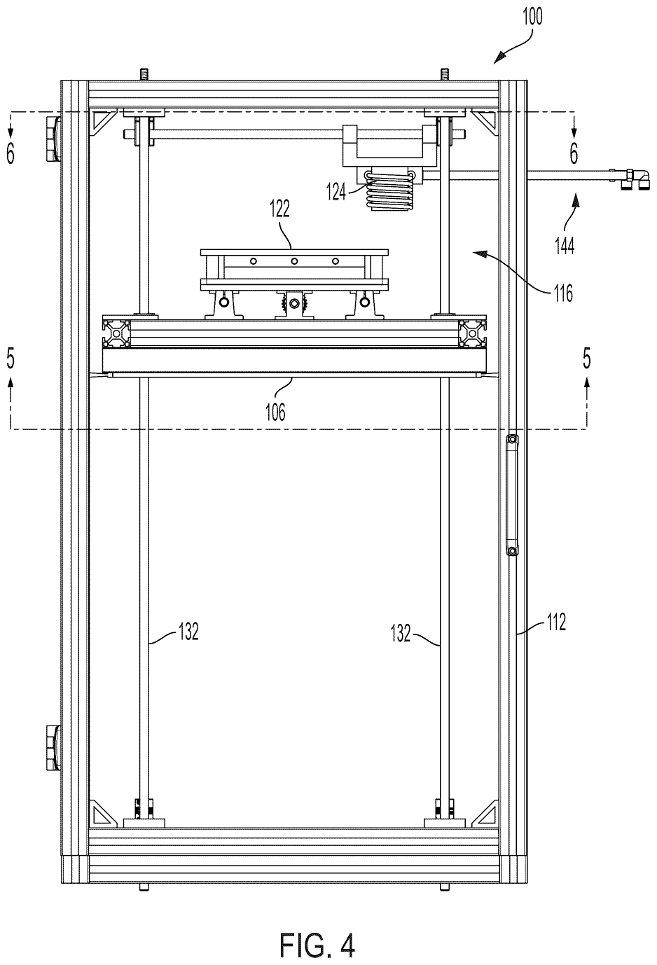

As shown in FIG. 4, the 3D printer 100 may include a print bed 122. The print bed 122 is the platform or area which receives the feedstock material being 3D printed as it is formed into the article of manufacture. The print bed 122 may be disposed on the plurality of stationary walls 104 or the adjustable wall 106. It may be beneficial to have the print bed 122 disposed on the bottom wall for some 3D printing techniques.

As shown in FIG. 4, the 3D printer 100 may also include a print head 124 for depositing feedstock onto the print bed 122 or previously printed layers of feedstock. For example, the print head 124 may be configured to melt feedstock (not shown) and dispense the molten feedstock (not shown) during 3D printing.

The 3D printer 100 may include a motion gantry 126. The motion gantry 126 may be a computer numerically controlled (CNC) gantry controlled by a controller (not shown). The motion gantry 126 may be secured to the plurality of stationary walls 104 and/or the frame 112, when present. The motion gantry 126 may be configured to move the adjustable wall 106 towards and away from the open interior 116 on a first axis. For example, the motion gantry 126 may be configured to move the adjustable wall 106 towards and away from the open interior 116 such that the volume of the open interior 116 increases or decreases at a rate less than the maximum rate.

As shown in FIG. 3, the motion gantry 126 may include a first motor 128 and a first translation screw 130. The first motor 128 may be a stepper or servo motor. The first motor 128 may be disposed outside of the open interior 116 to allow for the use of motors that are not sufficiently heat resistant to withstand the temperatures that may occur in the open interior 116.

The motion gantry 126 may also include a first translation screw 130. The first translation screw 130 may extend parallel to the first axis and may connect the adjustable wall 106 to the first motor 128. As used herein, a translation screw may be a screw, such as a lead screw or ball screw, configured to translate the rotational movement of a motor into the linear movement of another object. The first translation screw 130 may be configured to, when rotated by the first motor 128, translate the adjustable wall 106 parallel to the first axis. In some embodiments, the first motor 128 may be in line or coaxial with the first translation screw 130 to rotate the first translation screw 130 without the need for a power transmission system to transfer power from the first motor 128 to the first translation screw 130. In other embodiments, a power transmission system (not shown) may be used to connect and transfer power from the first motor 128 to the first translation screw 130.

The motion gantry 126 may also comprise a first plurality of guides 132 extending parallel to the first axis. The first plurality of guides 132 may be connected to the adjustable wall 106 and configured to limit the movement of the adjustable wall 106 to translation in the first axis. The first plurality of guides 132 and/or the first translation screw 130 may extend through apertures 134 in the adjustable wall 106. The apertures 134 may be sealed around the first translation screw 130 and the first plurality of guides 132 to prevent or reduce the flow of gas through the apertures 134.

In some embodiments, the motion gantry 126 may be secured to the print bed 122 and configured to translate the print bed 122 on a second axis perpendicular to the first axis. In such embodiments, the motion gantry 126 may include a second motor (not shown) and a second translation screw 136. The second motor may be a stepper or servo motor. As with the first motor 128, the second motor may be disposed outside of the open interior 116 to allow for the use of motors that are not sufficiently heat resistant to withstand the temperatures that may occur in the open interior 116.

The motion gantry 126 may also include a second translation screw 136. The second translation screw 136 may extend parallel to the second axis and may connect the print bed 122 to the second motor. The second translation screw 136 may be configured to, when rotated by the second motor, translate the print bed 122 parallel to the second axis. The second motor may be axially offset from the second translation screw 136 (i.e., not coaxial with the second translation screw 136). In such embodiments, a power transmission system (not shown) may be used to connect and transfer power from the second motor to the second translation screw 136. The power transmission system may include components such as drive shafts and bevel gears to transfer power from the second motor to the second translation screw 136. The components of the transmission system may be heat resistant to withstand the temperatures that occur within the open interior 116 of the build chamber 102.

The motion gantry 126 may also comprise a second plurality of guides 138 extending parallel to the second axis. The second plurality of guides 138 may be connected to the print bed 122 and configured to limit the movement of the print bed 122 to translation on the second axis.

In some embodiments, the motion gantry 126 may be secured to the print head 124 and configured to translate the print head 124 on a third axis perpendicular to the first and second axes. For example, the first axis may be a z-axis and the second and third axes may be x- and y-axes, respectively. In such embodiments, the motion gantry 126 may include a third motor (not shown) and a third translation screw 140. The third motor may be a stepper or servo motor. As with the first motor 128 and the second motor, the third motor may be disposed outside of the open interior 116 to allow for the use of motors that are not sufficiently heat resistant to withstand temperatures that may occur in the open interior 116.

The motion gantry 126 may also include a third translation screw 140. The third translation screw 140 may extend parallel to the third axis and may connect the print head 124 to the third motor. The third translation screw 140 may be configured to, when rotated by the third motor, translate the print head 124 parallel to the third axis. In some embodiments, the third motor may be in line or coaxial with the third translation screw 140 to rotate the third translation screw 140 directly without the need for a power transmission system. In other embodiments, a power transmission system (not shown) may be used to connect and transfer power from the third motor to the third translation screw 140.

The motion gantry 126 may also comprise a third plurality of guides 142 extending parallel to the third axis. The third plurality of guides 142 may be connected to the print head 124 and configured to limit the movement of the print head 124 to translation on the third axis.

The guides of the first plurality of guides 132, second plurality of guides 138, and third plurality of guides 142 may be any type of guide configured to limit the movement of the component to which it is attached (e.g., the adjustable wall 106, the print bed 122, or the print head 124) to linear or translational movement. Examples of guides that may be used in the first plurality of guides 132, second plurality of guides 138, and third plurality of guides 142 include but are not limited to guide rails, linear rails, linear rods, and tracks.

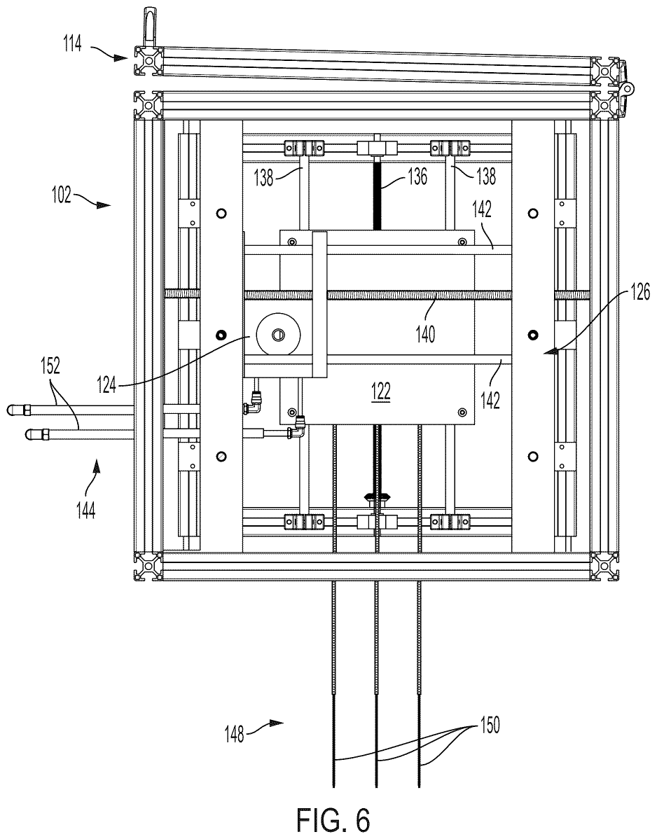

As shown in FIG. 6, the 3D printer 100 may also include other subsystems. For example, the 3D printer 100 may include a heating system 144 configured to heat the print bed 122, the print head 124, and/or the open interior 116 of the expandable build chamber 102. As another example, the 3D printer 100 may include a shielding gas system to supply shielding gas into the open interior 116. Shielding gas may be used in metal 3D print techniques to prevent atmospheric gases from oxidizing metal feedstock during printing. As a further example, the 3D printer 100 may include a power supply system 148 for supplying power to one or more of the print bed 122, the print head 124, the motion gantry 126, the heating system 144, the shielding gas system, or other subsystems of the 3D printer 100. It may be necessary to have apertures 134 in the plurality of stationary walls 104, adjustable walls 106, or the frame 112 for wires 150, tubes 152, or other components of the heating system 144, shielding gas system, and/or power supply system 148 to pass through. Such apertures 134 or any other breaches in the plurality of stationary walls 104, adjustable walls 106, or the frame 112 may also be sealed around the wires 150, tubes 152, or other components passing through the aperture 134 to prevent or reduce the flow of gas through the aperture 134.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A 3D printer for forming a 3D object from a feedstock material, the 3D printer comprising:
an expandable build chamber defined by a plurality of stationary walls and an adjustable wall, the walls enclosing an open interior isolated from the ambient environment and having an open interior volume;
a print bed for receiving the feedstock material as it is formed into the 3D object, the print bed disposed within the open interior; and
a print head for depositing the feedstock material onto the print bed, the print head disposed within the open interior, wherein the adjustable wall is configured to translate away from the open interior to increase the open interior volume as the print head deposits the feedstock material onto the print bed while maintaining isolation of the open interior from the ambient environment.

2. The 3D printer of claim 1, further comprising a seal affixed to and extending about a perimeter of the adjustable wall, wherein the seal is in contact with the plurality of stationary walls about the perimeter of the adjustable wall to prevent or reduce the flow of gas between the adjustable wall and the plurality of stationary walls.

3. The 3D printer of claim 2, wherein the seal is configured to maintain in contact with the plurality of stationary walls as the adjustable wall translates away from the open interior.

4. The 3D printer of claim 2, wherein the seal is a rope gasket or a brush seal.

5. The 3D printer of claim 1, wherein the plurality of stationary walls and the adjustable wall are heat resistant up to a temperature of at least 1000° F.

6. The 3D printer of claim 1, wherein the plurality of stationary walls and the adjustable wall are insulated.

7. The 3D printer of claim 1, wherein the expandable build chamber comprises a door configured to open to allow access to the open interior.

8. The 3D printer of claim 1, wherein the plurality of stationary walls include four sidewalls and a top wall, wherein the adjustable wall is a bottom wall, and wherein the adjustable wall is configured to translate downward to increase the open interior volume.

9. The 3D printer of claim 8, further comprising a frame securing together and forming a seal between the stationary walls.

10. The 3D printer of claim 9, further comprising a motion gantry secured to the frame and the adjustable wall and configured to move the adjustable wall away from the open interior on a first axis.

11. The 3D printer of claim 10, wherein the motion gantry is configured to move the adjustable wall away from the open interior such that the open interior volume increases at a rate less than one percent per minute.

12. The 3D printer of claim 10, wherein the motion gantry comprises a first translation screw connected to the adjustable wall and extending parallel to the first axis and a first motor configured to rotate the first translation screw, wherein the first translation screw is configured to, when rotated by the first motor, translate the adjustable wall on the first axis.

13. The 3D printer of claim 12, wherein the motion gantry comprises a first plurality of guides extending parallel to the first axis, connected to the adjustable wall, and configured to limit movement of the adjustable wall to translation on the first axis.

14. The 3D printer of claim 13, wherein the first translation screw and the first plurality of guides extend through apertures in the bottom wall, and wherein the apertures are sealed around the first translation screw and the guides.

15. The 3D printer of claim 13, wherein the print bed is disposed on the adjustable wall, wherein the motion gantry is secured to the print bed and configured to translate the print bed on a second axis perpendicular to the first axis.

16. The 3D printer of claim 15, wherein the motion gantry further comprises:
a second translation screw secured to the print bed and extending parallel to the second axis;
a second motor configured to rotate the second translation screw; and
a second plurality of guides extending parallel to the second axis, connected to the print bed, and configured to limit movement of the print bed to translation on the second axis,
wherein the second translation screw is configured to, when rotated by the second motor, translate the print bed on the second axis.

17. The 3D printer of claim 15, further comprising a heating system configured to heat the print bed, wherein the heating system extends through an aperture in the adjustable wall or one of the stationary walls, and wherein the aperture is sealed around the heating system.

18. The 3D printer of claim 17, wherein the motion gantry is secured to the print head and configured to translate the print head on a third axis perpendicular to the first and second axes.

19. The 3D printer of claim 18, wherein the motion gantry further comprises:
a third translation screw secured to the print head and extending parallel to the third axis;
a third motor configured to rotate the third translation screw; and
a third plurality of guides extending parallel to the third axis, connected to the print head, and configured to limit movement of the print head to translation on the third axis,
wherein the third translation screw is configured to, when rotated by the third motor, translate the print head on the third axis.

20. The 3D printer of claim 19, further comprising a power supply system configured to provide power to the print head, wherein the power supply system extends through an aperture in the adjustable wall or one of the stationary walls, and wherein the aperture is sealed around the power supply system.
